(19) United States
(12) Patent Application Publication
(10) Pub. No.: US 2025/0276536 A1
(43) Pub. Date: Sep. 4, 2025

(54) IMAGE FORMING APPARATUS AND IMAGE FORMING METHOD

(71) Applicant: Kimito Abe, KANAGAWA (JP)

(72) Inventor: Kimito Abe, KANAGAWA (JP)

(73) Assignee: Ricoh Company, Ltd., Tokyo (JP)

(21) Appl. No.: 19/057,231

(22) Filed: Feb. 19, 2025

(30) Foreign Application Priority Data
Feb. 29, 2024 (JP) 2024-030314
Oct. 9, 2024 (JP) 2024-177303

(51) Int. Cl. B41J 11/00; B41J 2/21

(52) U.S. Cl. CPC B41J 11/00242; B41J 2/2117

(57) ABSTRACT

An image forming apparatus includes a conveyor, a pretreatment liquid applier, an image former, a dryer, an image reader, and circuitry. The conveyor conveys a medium. The pretreatment liquid applier applies a pretreatment liquid onto the medium. The image former forms a specific image on the medium on which the pretreatment liquid has been applied. The dryer dries the pretreatment liquid before the image former forms the specific image. The image reader reads the specific image to acquire a read image. The circuitry determines an amount of the pretreatment liquid and a drying condition of the dryer based on the read image, controls the pretreatment liquid applier to apply the pretreatment liquid onto the medium for the amount of the pretreatment liquid determined based on the read image, and controls the dryer to dry the pretreatment liquid according to the drying condition determined based on the read image.

### CROSS-REFERENCE TO RELATED APPLICATIONS

This patent application is based on and claims priority pursuant to 35 U.S.C. § 119 (a) to Japanese Patent Applications Nos. 2024-030314, filed on Feb. 29, 2024, and 2024-177303, filed on Oct. 9, 2024, in the Japan Patent Office, the entire disclosure of each of which is hereby incorporated by reference herein.

### BACKGROUND

### Technical Field

Embodiments of the present disclosure relate to an image forming apparatus and an image forming method.

### Related Art

An image forming apparatus is known that forms an image on a medium while the medium is conveyed. A pretreatment liquid application apparatus is also known that applies a pretreatment liquid, which makes a condition of an image formation surface of the medium suitable for image formation, to a medium before an image is formed on the medium.

A configuration is known that controls the application amount of a pretreatment liquid and drying conditions of the pretreatment liquid based on the printing resolution for the purpose of preventing a defective image such as bleeding from being generated when liquid ink is attached to form an image on a medium.

### SUMMARY

In an embodiment of the present disclosure, an image forming apparatus includes a conveyor, a pretreatment liquid applier, an image former, a dryer, an image reader, and circuitry. The conveyor conveys a medium in a conveyance direction. The pretreatment liquid applier applies a pretreatment liquid onto the medium conveyed by the conveyor. The image former, downstream from the pretreatment applier in the conveyance direction, forms a specific image on the medium on which the pretreatment liquid has been applied. The dryer, which is disposed between the pretreatment applier and the image former in the conveyance direction, dries the pretreatment liquid applied onto the medium before the image former forms the specific image on the medium. The image reader, which is disposed downstream from the image former in the conveyance direction, reads the specific image on the medium to acquire a read image. The circuitry determines an amount of the pretreatment liquid which the pretreatment liquid applier applies and a drying condition of the dryer based on the read image acquired by the image reader, controls the pretreatment liquid applier to apply the pretreatment liquid onto the medium for the amount of the pretreatment liquid determined based on the read image, and controls the dryer to dry the pretreatment liquid on the medium according to the drying condition determined based on the read image.

In another embodiment of the present disclosure, an image forming apparatus includes a pretreatment liquid applier, a dryer, an image former, a conveyor, an image reader, and circuitry. The pretreatment liquid applier applies a pretreatment liquid to a medium. The dryer dries the pretreatment liquid applied to the medium. The image former forms a specific image on the medium on which the pretreatment liquid has been dried. The conveyor conveys the medium to the pretreatment liquid applier, the dryer, and the image former in this order, and conveys the medium on which an image has been formed downstream in a conveyance direction. The image reader downstream from the image former in the conveyance direction, acquires a read image of the image including the specific image formed on the medium and read by the image reader. The circuitry controls an amount of the pretreatment liquid and a drying condition of the pretreatment liquid, and determines a control condition of the pretreatment liquid applier and the dryer in accordance with a determination result based on luminance values of read images, and controls operations of the pretreatment applier and the dryer in accordance with the control condition.

In still another embodiment of the present disclosure, an image forming method includes applying, drying, forming, reading, and determining. The applying applies a pretreatment liquid to a medium. The drying dries the pretreatment liquid applied to the medium. The forming forms a specific image on the medium on which the pretreatment liquid has been dried, while conveying the medium. The reading reads an image including the specific image formed on the medium after the specific image is formed. The determining determines a control condition of the applying the pretreatment liquid and the drying the pretreatment liquid in accordance with a determination result of color bleeding based on a luminance value of the read image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating an example of a test chart to be formed, according to an embodiment of the present disclosure;

FIG. 3 is a diagram illustrating another example of a test chart to be formed, according to an embodiment of the present disclosure;

FIG. 4 is a flowchart of a process of creating the test charts of FIGS. 2 and 3, according to an embodiment of the present disclosure;

FIG. 5 is a diagram illustrating an example of a determination result based on a test chart for density determination, according to an embodiment of the present disclosure;

FIG. 6 is a diagram illustrating a relation between density ranks and density ranges, according to an embodiment of the present disclosure;

FIG. 7 is a partially enlarged view of a test chart for color bleeding determination, according to an embodiment of the present disclosure;

FIG. 8 is a graph illustrating relations between luminance values and measurement coordinates of the test chart for color bleeding determination of FIG. 7, according to an embodiment of the present disclosure;

FIG. 9 is a graph illustrating relations between luminance values and measurement coordinates of the test chart for color bleeding determination of FIG. 7, employed to determine whether color bleeding occurs, according to an embodiment of the present disclosure;

FIG. 10 is a diagram illustrating a relation between color bleeding ranks and color bleeding determination values, according to an embodiment of the present disclosure;

FIG. 11 is a partially enlarged view of a test chart for color bleeding determination, according to an embodiment of the present disclosure;

FIG. 12 is a graph illustrating relations between luminance values and measurement coordinates of the test chart for color bleeding determination of FIG. 11, employed to determine whether color bleeding occurs, according to an embodiment of the present disclosure;

FIG. 13 is a flowchart of a process of adjusting application conditions and drying conditions of pretreatment liquid, according to an embodiment of the present disclosure;

FIGS. 14A, 14B, and 14C are diagrams each illustrating data generated in the process of adjusting application conditions and drying conditions of pretreatment liquid of FIG. 13, according to an embodiment of the present disclosure; and

FIG. 15 is a diagram illustrating an overall configuration of an image forming apparatus, according to another embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

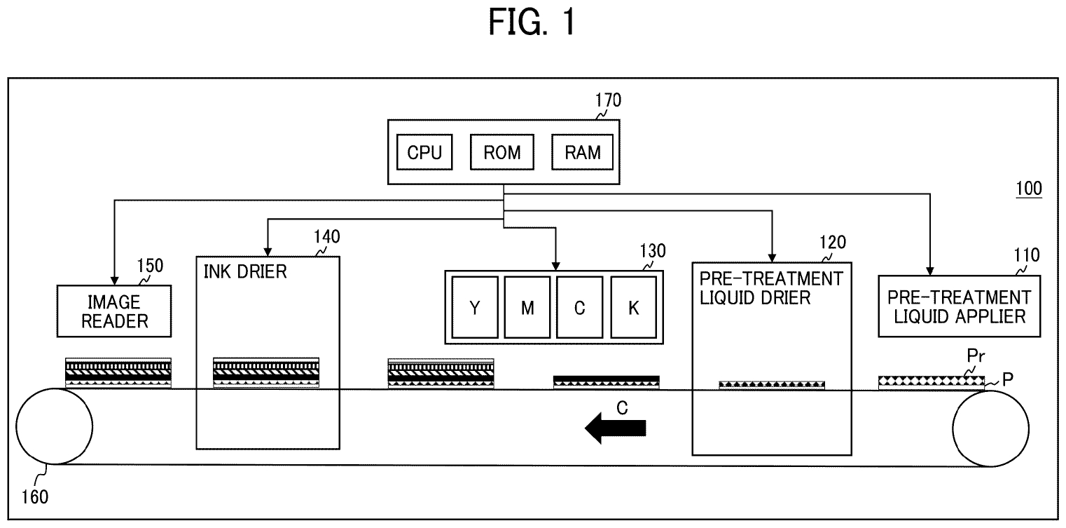

Embodiments of the present disclosure will be described below with reference to the drawings. FIG. 1 is a diagram illustrating an overall configuration of a line-type inkjet printer 100 as an image forming apparatus according to an embodiment of the present disclosure. An image forming method according to embodiments of the present disclosure is a so-called inkjet method in which liquid ink is discharged to a sheet P as a sheet-shaped medium to form an image.

As described below, in embodiments of the present disclosure, before an image is formed on a sheet P, a treatment agent that makes a condition of a surface of the sheet P, on which an image is to be formed, suitable to enhance the image quality is applied in advance. Then, an image is formed on the surface of the sheet P on which the treatment agent has been applied. For this reason, the image forming method of embodiments of the present disclosure may be a direct image formation method or an indirect image formation method in which secondary transfer is performed via intermediate transfer.

As illustrated in FIG. 1, the inkjet printer 100 includes a pretreatment liquid applier 110 to apply pretreatment liquid Pr as a treatment agent to the sheet P. The pretreatment liquid applier 110 is disposed upstream from an image former 130 in a sheet conveyance direction. The pretreatment liquid applier 110 applies the pretreatment liquid Pr to a surface of the sheet P on which an image is to be formed. The pretreatment liquid Pr has an effect of making the condition of the surface of the sheet P suitable for improving the image quality.

The pretreatment liquid applier 110 includes an inkjet head, and discharges the pretreatment liquid Pr from the inkjet head to apply the pretreatment liquid Pr to the sheet P. The pretreatment liquid applier 110 controls a pattern of discharging the pretreatment liquid Pr from the inkjet head (a pattern of discharge operation). By so doing, the pretreatment liquid applier 110 can change the application amount of the pretreatment liquid Pr.

The inkjet printer 100 also includes a pretreatment liquid drier 120 to dry the pretreatment liquid Pr applied to the sheet P. The pretreatment liquid drier 120 is disposed downstream from the pretreatment liquid applier 110 and upstream from an image former 130 in the sheet conveyance direction.

The inkjet printer 100 includes the image former 130. The image former 130 discharges liquid ink to a sheet P on which the pretreatment liquid Pr has been dried to form an image. The image former 130 is disposed downstream from the pretreatment liquid drier 120 in the sheet conveyance direction.

The image former 130 includes liquid discharge units to discharge liquid inks of multiple colors to the image forming surface of the sheet P to which the pretreatment liquid Pr has been dried and applied. For example, the image former 130 discharges the liquid inks of the multiple colors in the sheet conveyance direction indicated by arrow C in FIG. 1, at a predetermined timing and with a predetermined amount in the order of K (black), C (cyan), M (magenta), and Y (yellow) toward the sheet P to form an image.

The image former 130 forms various types of image. For example, the image former 130 forms a test chart as a specific image in which rectangular images painted in a specific color are arranged. In the test chart, colors of the multiple rectangular images arranged and adjacent to each other are different colors in a complementary color relation, and the test chart is employed to check the quality of an image formed by the image former 130.

The inkjet printer 100 further includes an ink drier 140 to dry the liquid inks applied to the sheet P by the image former 130 to fix the image. The ink drier 140 is disposed downstream from the image former 130 in the sheet conveyance direction.

The inkjet printer 100 further includes an image reader 150 that reads an image formed on the sheet P and acquires the read image. The image reader 150 is disposed downstream from the ink drier 140 in the sheet conveyance direction. The image reader 150 optically reads the image formed by the image former 130 and acquires a read image. The image reader 150 includes an image sensor to acquire, for example, test charts formed on the sheet P as read images.

The inkjet printer 100 includes a conveyor 160 as a medium conveyor to convey a sheet P to the pretreatment liquid applier 110, the pretreatment liquid drier 120, the image former 130, the ink drier 140, and the image reader 150 in the order listed.

The inkjet printer 100 also includes a controller 170 to control operations of the pretreatment liquid applier 110, the pretreatment liquid drier 120, the image former 130, the ink drier 140, the image reader 150, and the conveyor 160. The controller 170 has a configuration similar to the configuration of a so-called data processing apparatus, and includes a combination of an arithmetic device such as a central processing unit (CPU), storage devices such as a read-only memory (ROM), and a random-access memory (RAM).

The controller 170 causes the above-described hardware components to perform processing of computer software. By so doing, the controller 170 can execute following control processing.

The controller 170 controls the operations of the above-described hardware components, and determines the density and a condition of color bleeding of a specific image included in the read image acquired by the image reader 150. The controller 170 determines control conditions of the pretreatment liquid applier 110 and the pretreatment liquid drier 120 in accordance with a determination result of the specific image, and controls the operations of the pretreatment liquid applier 110 and the pretreatment liquid drier 120.

If the read image is a test chart, the controller 170 adjusts the application amount of the pretreatment liquid Pr to be applied to the sheet P and the drying condition of the pretreatment liquid Pr based on the density and the condition of the color bleeding of the test chart. Accordingly, the controller 170 allows a more favorable condition in which an image is formed to be obtained.

The controller 170 calculates, for example, a density value and determines a color bleeding condition of a read image to determine the image condition of the read image. For example, the controller 170 uses a lookup table in which luminance values and spectral characteristic values of pixels forming an image are associated with each other, to calculate the density value of the image. The controller 170 determines the color bleeding condition based on the amount of change in the luminance values of a color boundary area included in the specific image constituting the test chart.

### Examples of Test Chart

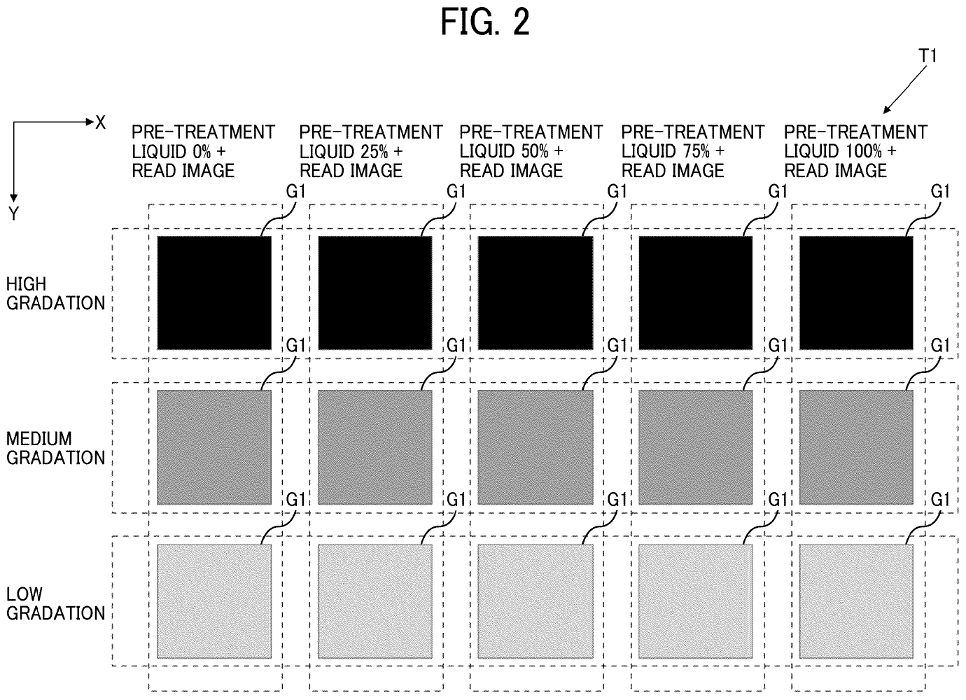

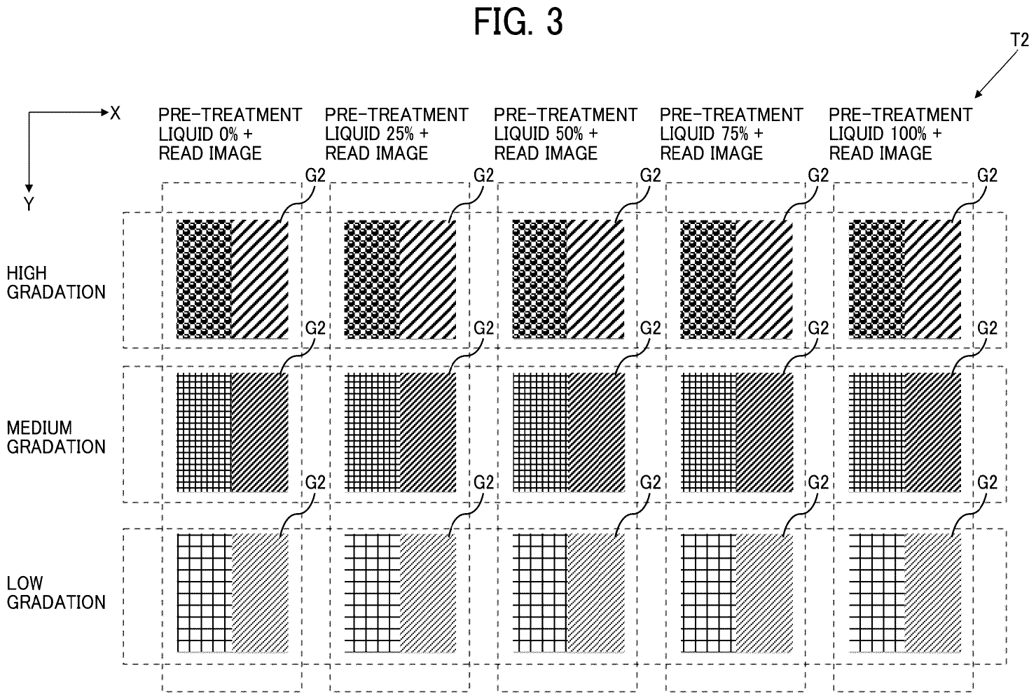

A description is given of examples of test charts with reference to FIGS. 2 and 3.

The test charts are specific images to be employed for adjusting the application condition and the drying condition of the pretreatment liquid Pr in the inkjet printer 100. FIG. 2 is a schematic diagram illustrating a test chart T1 for determining image density, according to an embodiment of the present disclosure.

FIG. 3 is a schematic diagram illustrating a test chart T2 for determining color bleeding condition, according to an embodiment of the present disclosure.

In the inkjet printer 100, the test chart T1 for determining image density and the test chart T2 for determining color bleeding condition are employed to adjust the application condition and the drying condition of the pretreatment liquid Pr. The test chart T1 for determining image density may also be referred to simply as the test chart T1 in the following description. The test chart T2 for determining color bleeding condition may also be referred to simply as the test chart T2 in the following description. More specifically, the test chart T1 and the test chart T2 are formed on the sheet P, and the sheet P on which the test charts T1 and T2 are formed, is conveyed to the image reader 150.

Subsequently, the image reader 150 acquires a read image from each of the test charts T1 and T2, and notifies the controller 170 that the read images are acquired. The controller 170 determines image formation conditions of the read images of the test charts T1 and T2, and adjusts the application amount and the drying conditions of the pretreatment liquid Pr based on the determination result.

The controller 170 determines the density of a first read image G1 of the test chart T1, scanned by the image reader 150. The controller 170 determines a degree of color bleeding based on a condition in which different colors bleed into each other in a color boundary area between the different colors in a second read image G2 of the test chart T2 read by the image reader 150.

In other words, the controller 170 determines whether color bleeding is present based on the amount of change in brightness of rectangular images adjacent to each other of the second read image G2.

As illustrated in FIG. 2, the test chart T1 includes the multiple first read images G1. Each of the first read image G1 is formed as a solid image in a single color.

Each of the first read images G1 has a different combination of image density, which is density of the printed image, and the application amount of the pretreatment liquid Pr applied before the image formation. In the test chart T1, each of the first read images G1 that are arranged has a same image density and the application amount of the pretreatment liquid Pr applied to each of the first read images G1 is different in X direction in FIG. 2. In other words, in FIG. 2, the first read images G1 are arranged such that the application amount of the pretreatment liquid Pr that is applied to each of the first read images G1 is increased from 0% to 25%, 50%, 75%, and 100% from left to right in the X direction.

In addition, in the test chart T1, the first read images G1 that are arranged have a same application amount of the pretreatment liquid Pr applied to the first read images G1 and have a different image density in Y direction in FIG. 2. In other words, in FIG. 2, the first read images G1 are arranged such that the image density of the first read images G1 decreases from top to bottom in the Y direction in FIG. 2, such as from high gradation to medium gradation, and low gradation.

As illustrated in FIG. 3, the test chart T2 includes multiple second read images G2. In each of the second read images G2, solid images of different colors are arranged adjacent to each other. Each of the second read images G2 has a different combination of the image density, which is density of the printed image, of the solid images in complementary colors arranged adjacent to each other and the application amount of the pretreatment liquid Pr applied before the image formation. Colors included in each of the second read images G2 may be, for example, a combination of complementary colors, such as when one of the colors is green, the other is red.

As illustrated in FIG. 3, also in the test chart T2, the second read images G2 that are arranged have a same image density and a different amount of the pretreatment liquid Pr applied to the second read images G2 in the X direction in FIG. 3, in a similar manner to FIG. 2. In other words, in also FIG. 3, the second read images G2 are arranged such that the application amount of the pretreatment liquid Pr that is applied to each of the second read images G2 increases from 0% to 25%, 50%, 75%, and 100% from left to right in the X direction.

In the test chart T2, the second read images G2 are arranged such that the application amount of the pretreatment liquid Pr applied to the second read images G2 is similar and the image density of the second read image G2 is different in the Y direction in FIG. 3. In other words, in FIG. 3, the second read images G2 are arranged such that the image density of the second read images G2 decreases from top to bottom in FIG. 3, such as from high gradation to medium gradation, and low gradation.

The numerical value of the application amount of the pretreatment liquid Pr indicates discharge patterns of the pretreatment liquid Pr discharged from the inkjet head included of the pretreatment liquid applier 110. The discharge pattern of the inkjet head changes in accordance with the numerical value of the application amount of the pretreatment liquid Pr. By so doing, the discharge pattern of the pretreatment liquid Pr to be applied to the sheet P is changed. Thus, the application amount of the pretreatment liquid Pr applied to an area of the printed image, which corresponds with corresponding one of the second scanned images G2, can be changed. In other words, changing the discharge pattern of the inkjet head allows the application amount of the pretreatment liquid Pr to be changed for each of the printed images, i.e., the second scanned images G2 constituting the test chart T2. In the present embodiment, the high gradation, the medium gradation, and the low gradation in FIGS. 2 and 3 are gradations each corresponding to, for example, a substantially median value of thee gradation ranges obtained by dividing 100% into three parts when the maximum density of a printed image formable by the inkjet printer 100 is set to gradation of 100%. In other words, in FIG. 2, when the gradation of 100% is divided into three ranges (100 to 67%, 66 to 34%, and 33 to 0%), a gradation of 83% which is a substantially median value of 100 to 67%, is set as the high gradation, a gradation of 50% is set as the medium gradation, and a gradation of 17% is set as the low gradation.

As described above, in the inkjet printer 100, when the controller 170 adjusts the application condition and the drying condition of the pretreatment liquid Pr, the controller 170 refers to the test chart T1 in which the rectangular images of a single color, i.e., the first read images G1, are arranged, to determine the density value of each of the rectangular images filled with the single color. In addition, the controller 170 refers to the test chart T2 in which the rectangular images, i.e., the second read images G2, including patch images in different colors, to determine the degree of color bleeding based on the degree to which colors arranged adjacent to each other bleed into each other in the color boundary area of the patch images.

### Procedure of Creating Test Charts

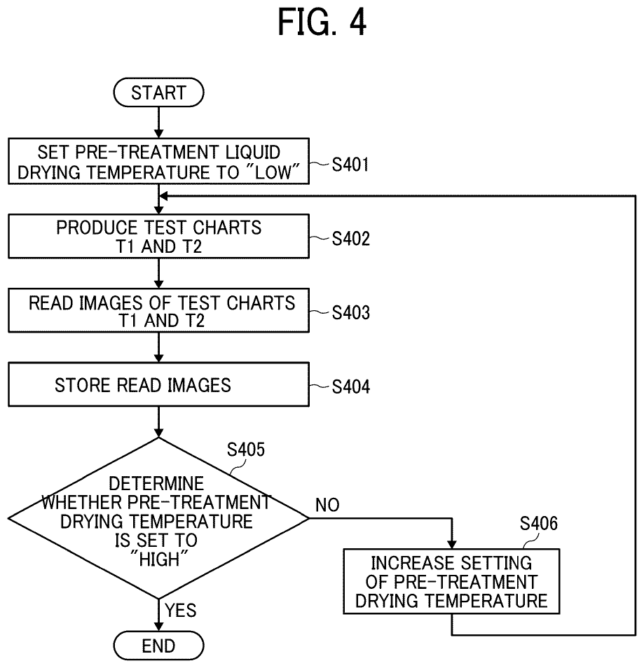

Next, a description is given of a method of creating the test charts T1 and T2, which is one of image generation methods performed by the inkjet printer 100, is described with reference to a flowchart of FIG. 4. First, the initial setting of the temperature in the pretreatment liquid drier 120 is set to low (step S401). Parameters that can be set for the temperature in the pretreatment liquid drier 120 include, for example, medium and high in addition to low. In the present embodiment, low, medium, and high as the temperature settings are relative terms. As an example, low is 80° C., medium is 100° C., and high is 120° C.

Subsequently, the image forming process for creating the two test charts, i.e., the test chart T1 for determining image density and the test chart T1 for determining image density, illustrated in FIGS. 2 and 3 is executed (step S402).

Subsequently, the two test charts T1 and T2 that have been formed in step S402 are conveyed to the image reader 150 by the conveyor 160. The image reader 150 reads the test charts T1 and T2 to acquire the read images G1 and G2, respectively (step S403).

Subsequently, the controller 170 stores the read images G1 and G2 acquired in step S403 in association with the setting of pretreatment liquid drying temperature (step S404).

Subsequently, the controller 170 determines whether the setting of the pretreatment liquid drying temperature is set to high (step S405).

If the setting of the pretreatment liquid drying temperature is not high (NO in step S405), the controller 170 increases the setting of the pretreatment liquid drying temperature from low to medium and from medium to high (step S406), and proceeds the processing to step S402.

If the pretreatment liquid drying temperature is high (YES in step S405), the controller 170 ends the processing.

As described above, the two types of the test charts, i.e., the test charts T1 and T2, are formed for each of the drying conditions of the pretreatment liquid Pr, i.e., the setting of the pretreatment liquid drying temperature. The controller 170 obtains and stores the read images of the test charts T1 and T2. The flowchart of FIG. 4 is an example in which the drying condition is defined as the drying temperature of the pretreatment liquid Pr. FIG. 4 illustrates a process in which the test charts T1 and T2 are formed to acquire the first read images G1 and the second read images G2, respectively, under the three settings of low, medium, and high of the pretreatment liquid drying temperature.

### Density Determination

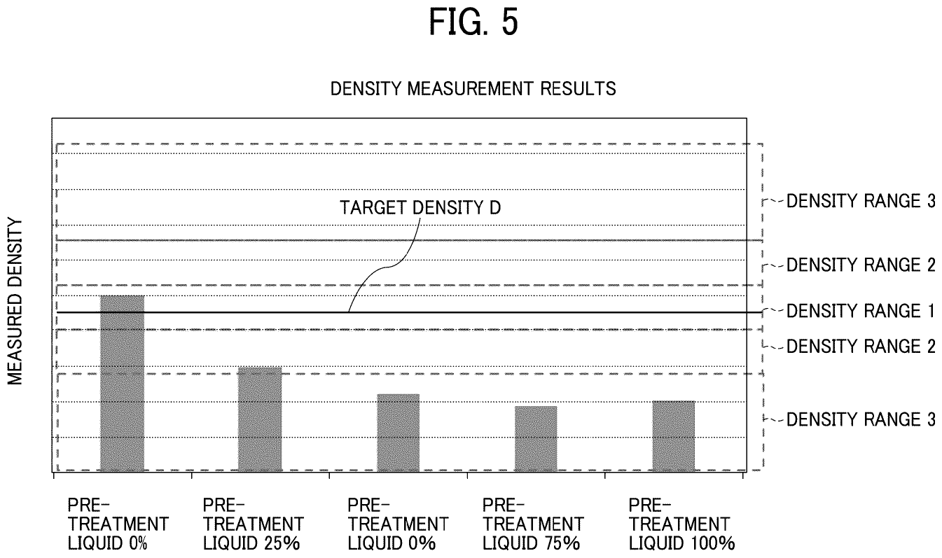

Next, a description is given of an example of a density determination result in which the test chart T1 for determining image density of the present embodiment, is employed with reference to FIG. 5. FIG. 5 is a diagram illustrating measurement results of the density in association with the ink adhesion amount, according to an embodiment of the present disclosure. The image reader 150 measures the ink adhesion amount for each of the high gradation, the medium gradation, and the low gradation.

The image reader 150 calculates the density of each of the first read images G1 of the test chart T1. The controller 170 stores in advance density level data to determine the density of the ink adhesion amount in a storage area of the controller 170, in a nonvolatile storage element such as the ROM (see FIG. 1) included in the controller 170. In the following description, the storage area to store the density level data implemented by the ROM included in the controller 170 is simply referred to as the storage area of the controller 170.

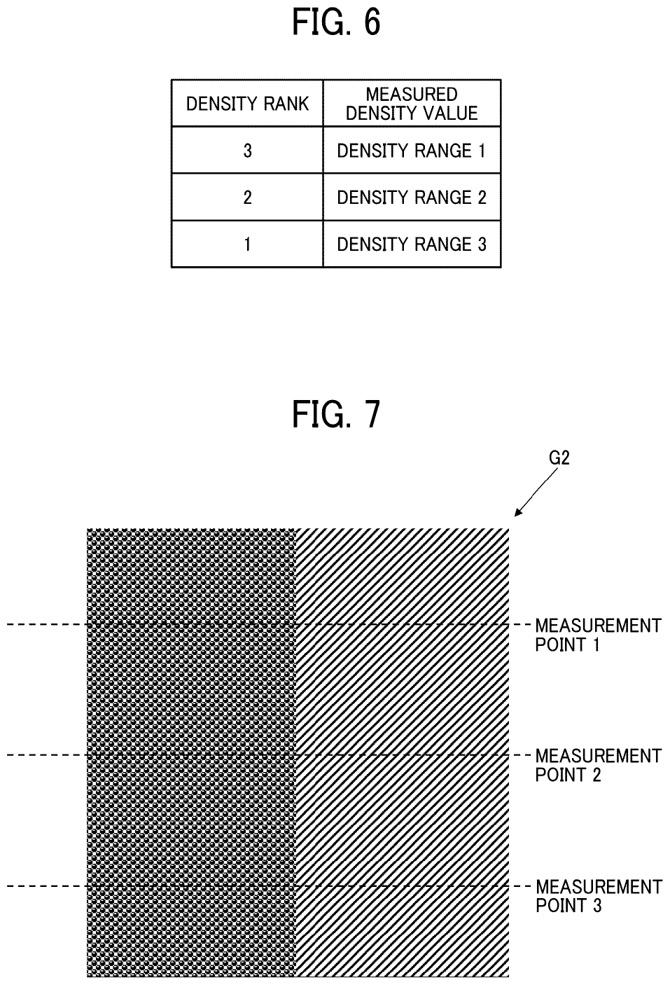

The controller 170 determines whether the measured density of each of the first read images G1 falls into which of density ranges 1, 2, or 3 (see FIG. 5). The relation between density ranks 1, 2, 3 and the density ranges 1, 2, and 3 to which the determined density rank is associated with is illustrated in FIG. 6. In other words, the density rank can be determined from the measured density value of the density range based on the relation illustrated in FIG. 6. Different values are set for the density ranges 1, 2, and 3 illustrated in FIG. 5, depending on the ink adhesion amount of the rectangular image, i.e., the first scanned images G1, measured by the image reader 150.

A description is given of the density range 1, the density range 2, and the density range 3 illustrated in FIG. 6 in more detail. The controller 170 stores the density range 1, the density range 2, and the density range 3 as data in advance in the storage area of the controller 170, and the density range 1, the density range 2, and the density range 3 are data corresponding to determination conditions to determine the degree of the measured density. The relation between a target density value (target density D) in each of the density ranges 1, 2, and 3 and the measured density when the rectangular images, i.e., the first scanned images G1, are formed, is, for example, as follows.

The density range 1 corresponds to a range of ±0.1 with respect to the target density D. The target density D may also be referred to simply as D in the following description. In other words, D−0.1≤ the measured density≤D+0.1 is satisfied.

The density range 2 corresponds to a range of −0.1 to −0.3 or a range of +0.1 to +0.3 with respect to the target density D. In other words, the relation: D−0.3≤measured density<D−0.1 or D+0.3<measured density≤D+0.3 is satisfied.

The density range 3 corresponds to a range of −0.3 to −0.5 or a range of +0.3 to +0.5 with respect to the target density D. In other words, the measured density<D−0.3 or D+0.3<the measured density is satisfied.

In other words, the controller 170 refers to the above-described density ranges 1, 2, and 3 and changes the target density D to be employed to determine the density rank in accordance with the first read image G1. By so doing, the controller 170 performs the above-described processing.

### Color Bleeding Determination

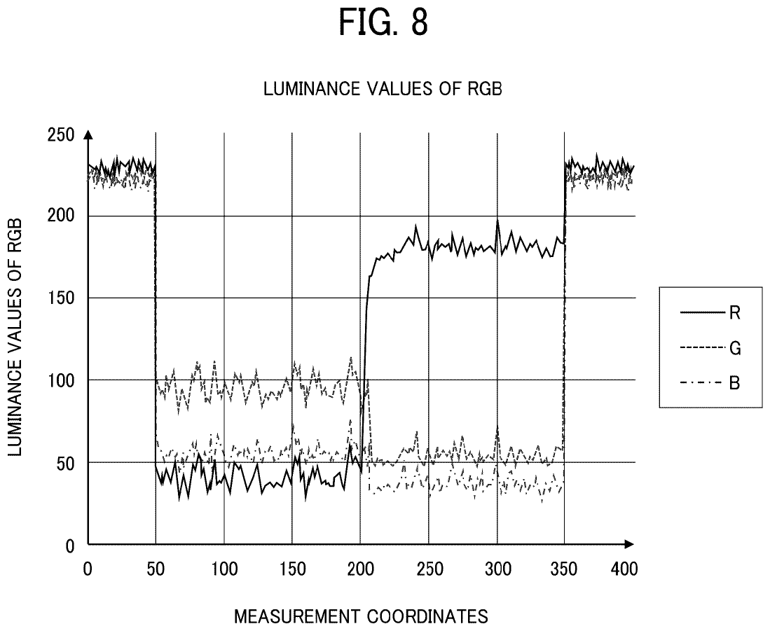

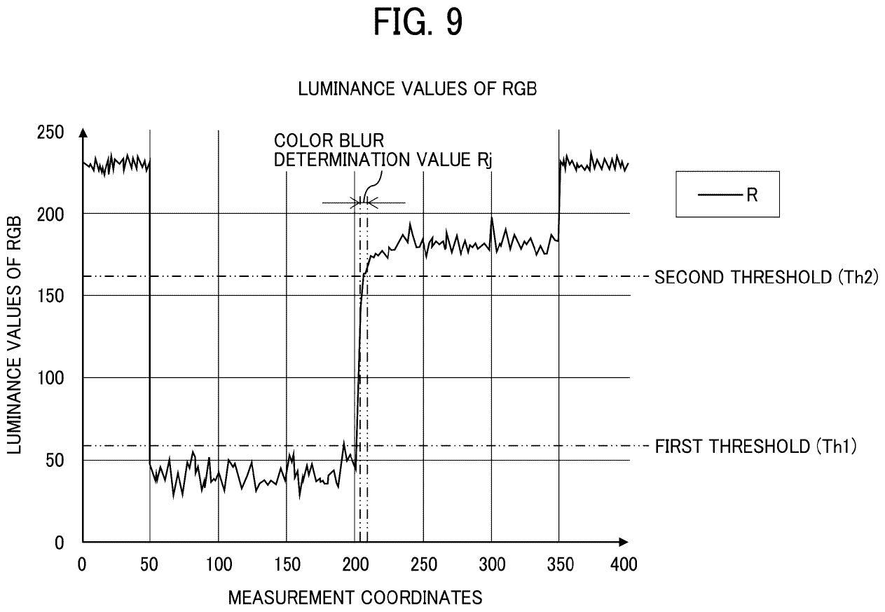

Next, a description is given of an example of a determination result using the test chart T2 for determining color bleeding with reference to FIG. 7, according to the present embodiment. FIG. 7 is an enlarged diagram illustrating the second read image G2 included in the test chart T2 to illustrate an example of measurement positions to measure the brightness of the second read image G2. FIG. 8 is a graph illustrating relations between luminance values and measurement coordinates of the test chart T2 for color bleeding determination, according to an embodiment of the present disclosure;

The image reader 150 obtains the second read image G2 illustrated in FIG. 7 and notifies the controller 170. The controller 170 sets multiple measurement points 1, 2, and 3 to measure the second read image G2 as illustrated in FIG. 7, and calculates a bleeding rank to determine the degree of the color bleeding based on the luminance data at the measurement points 1, 2, and 3.

FIG. 8 is a graph illustrating an example of luminance values measured at one of the measurement points 1, 2, or 3. The image reader 150 reads an image by the image sensor and acquires luminance values of red, green, and blue (RGB) of pixels included in one of the measurement points 1, 2, and 3 from the read image.

FIG. 8 is a graph in which the horizontal axis represents measurement coordinates of pixels included in one of the measurement points 1, 2, and 3, and the vertical axis represents luminance values of RGB of pixels at the measurement coordinates.

As illustrated in FIG. 8, the luminance values of RGB of the pixels at the measurement coordinates included in one of the measurement points 1, 2, and 3 of the second read image G2, in which rectangular images of different colors are formed side by side, change significantly in specific ranges of the measurement coordinates. The ranges of the measurement coordinates in which the luminance values of RGB change significantly correlate with color boundary areas between the different colors. In other words, whether the color bleeding occurs may be determined based on data of the color boundary area in which the change rates of the luminance values are large. In the case of FIG. 8, it is understood that whether the color bleeding occurs is determined based on data of red (R).

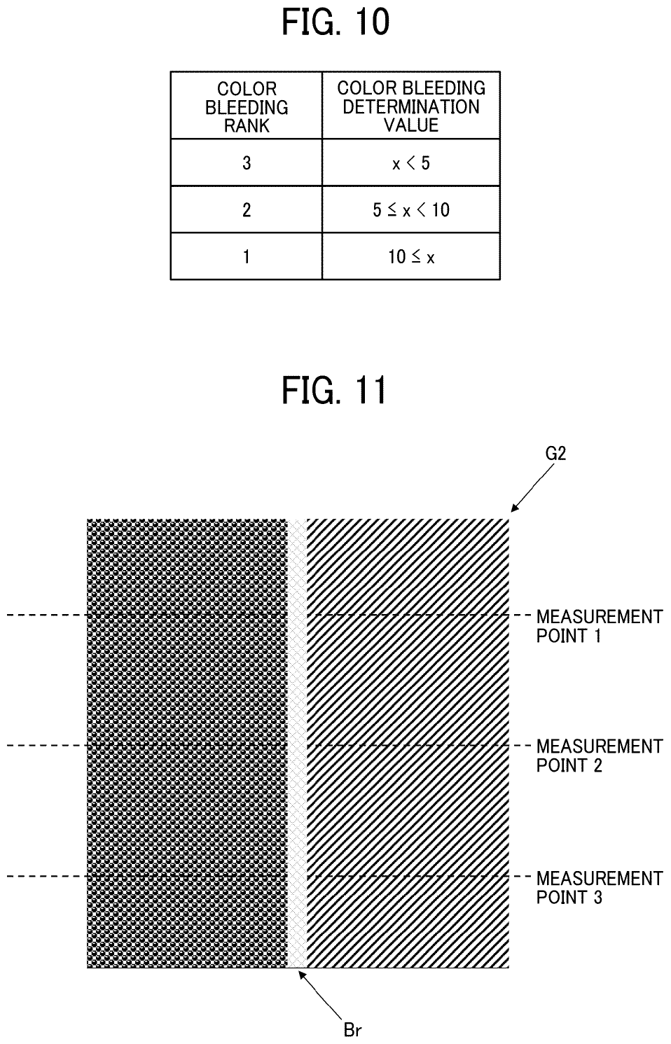

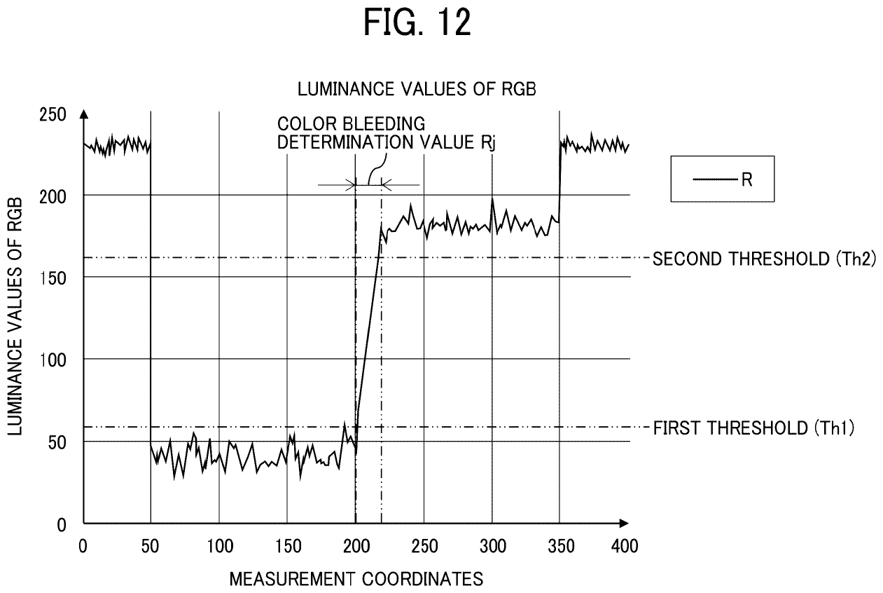

FIG. 9 is a graph illustrating an example of the color bleeding determination processing. FIG. 9 illustrates only the luminance values of red (R) employed for the color bleeding determination processing, which is extracted from FIG. 8. FIG. 10 is a diagram illustrating a relation between the color bleeding determination values (the number of pixels) and the color bleeding rank.

In the color bleeding determination processing, the controller 170 calculates the color bleeding determination values illustrated in FIG. 10 to determine the color bleeding rank in accordance with the numerical value of the color bleeding determination value.

The controller 170 stores two threshold values to calculate the color bleeding determination value in the storage area. In the color boundary area defined by the above-described two threshold values, a width Rj (the number of pixels, see FIG. 9) of the luminance values between the first and second thresholds Th1 and Th2 is the color bleeding determination value. The width Rj corresponds to the width of an area (illuminance-changing area) in which the luminance values change significantly in a color boundary area between different colors arranged adjacent to each other.

The threshold values Th1 and Th2 illustrated in FIG. 9 are merely examples. The threshold values Th1 and Th2 differ depending on the color of the second read image G2 and the RGB type for which the color bleeding determination value is calculated. The color bleeding determination value is the width of an area in which inks of colors arranged adjacent to each other are mixed. The smaller the color bleeding determination value, the better the degree of color bleeding. The controller 170 calculates the color bleeding determination value illustrated in FIG. 9 for each of the measurement points 1, 2, and 3 illustrated in FIG. 7, and determines the color bleeding rank based on a largest color bleeding determination value.

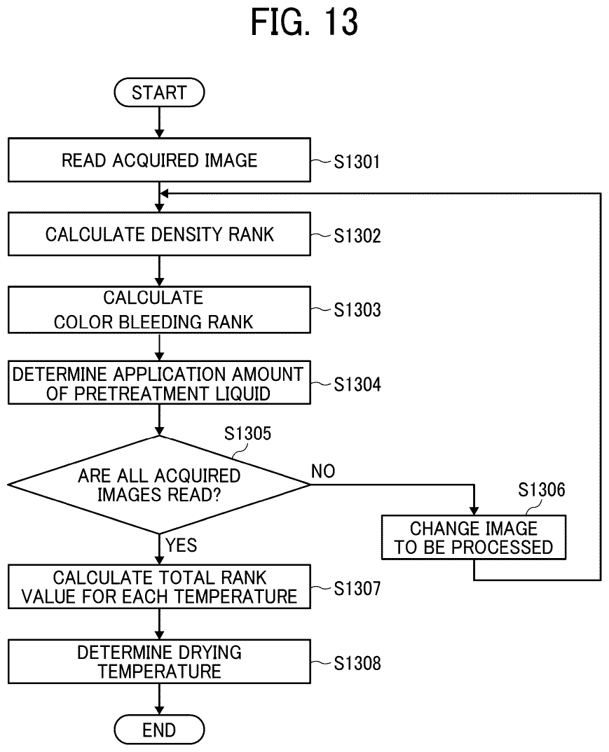

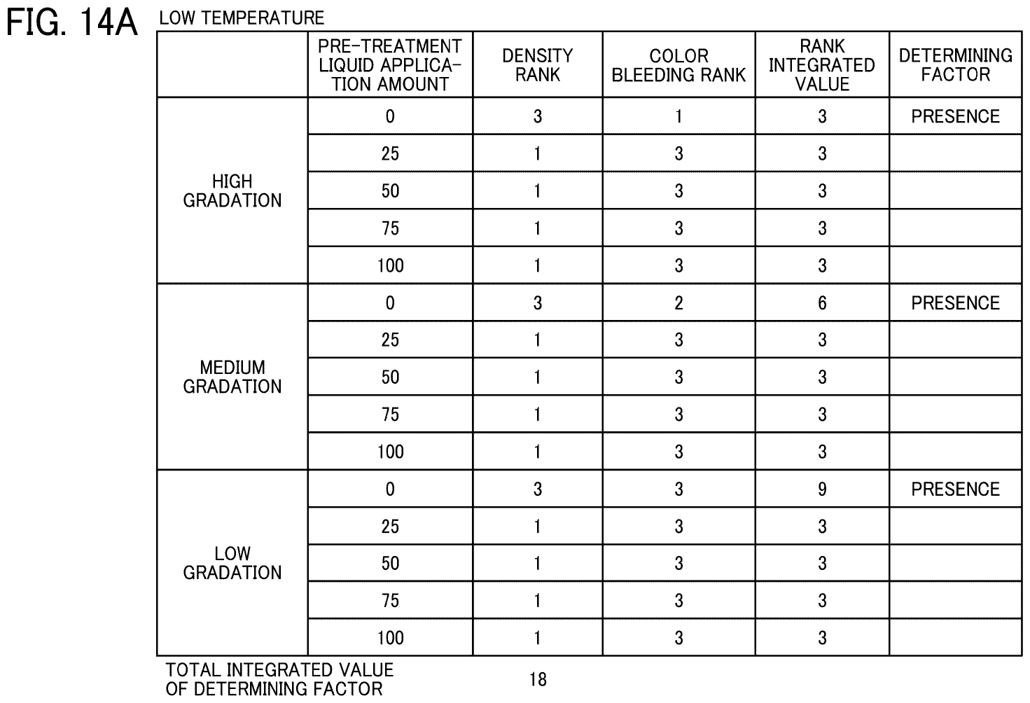

FIG. 11 is a diagram illustrating an example of the second read image G2 in which the color bleeding occurs in a color boundary area between the rectangular images arranged adjacent to each other included in the second read image G2. FIG. 12 is a graph illustrating an example of the color bleeding determination value at the measurement points 1, 2, and 3 illustrated in FIG. 11.

FIG. 11 illustrates a condition in which the color bleeding occurs in a color boundary area Br between rectangular images arranged adjacent to each other of the second read image G2. The rectangular images are in different colors having a complementary relation as specific colors constituting the second read image G2. FIG. 12 is a graph illustrating an example in which the luminance values of the pixels are measured at the measurement points 1, 2, and 3 in a direction in which the rectangular images of colors arranged adjacent to each other of the second read image G2 of FIG. 11. FIG. 12 illustrates only the luminance values of red (R) having largest amounts of change (change ratio) in the luminance values. As illustrated in FIG. 12, when the color bleeding occurs in the color boundary area between different colors arranged adjacent to each other, the width Rj of the color bleeding determination value is larger than the width Rj of the color bleeding determination value (see FIG. 9) when the color bleeding does not occur.

Flowchart of Process to Determine Pretreatment Application Condition

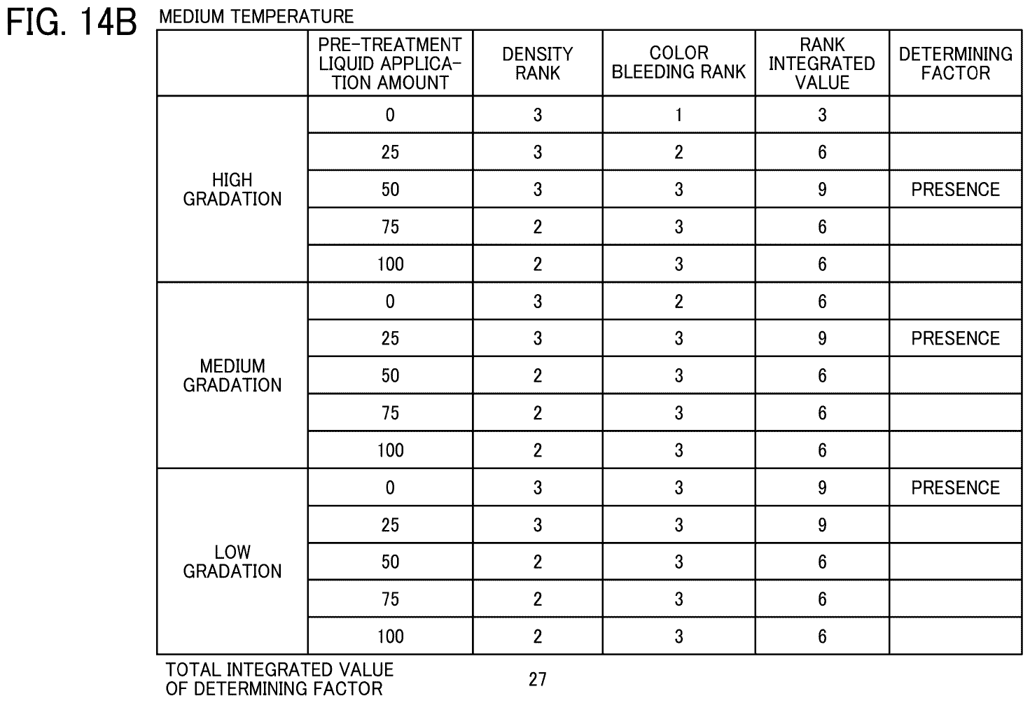

Next, a description is given of a process to determine a condition of the pretreatment liquid application with reference to the flowchart of FIG. 13. First, the controller 170 reads the first read images G1 and the second read images G2 acquired and stored with the drying condition set to the predetermined temperature in the process described in FIG. 4 (step S1301). Then, the controller 170 calculates the density rank of the first read images G1 and the second read images G2 (step S1302). Subsequently, the controller 170 calculates the color bleeding rank of the first read images G1 and the second read images G2 (step S1303).

Subsequently, the controller 170 determines the application amount of the pretreatment liquid Pr corresponding to the temperature setting of the read the first read images G1 and the second read images G2 based on the calculated color bleeding rank. The controller 170 calculates an integrated value of the calculated density rank and color bleeding rank for each of the first scanned images G1 and the second scanned images G2 on which the density rank and the color bleeding rank, respectively, have been determined, and sets the largest integrated value as the application amount of the pretreatment liquid Pr. When the integrated values corresponding to multiple application amounts of the pretreatment liquid Pr are the same, a condition that includes a smallest application amount of the pretreatment liquid Pr is determined as the condition of the pretreatment application amount for each of the low, medium, and high temperature settings.

After the controller 170 determines the application amount of the pretreatment liquid Pr for each of the temperature settings, the controller 170 calculates the total value of the integrated values of the pretreatment application amount of each of the patch images and compares the total values of the integrated values at each of the temperature settings. By so doing, the controller 170 determines the temperature setting. The controller 170 sets the temperature setting such that the total integrated value of the density ranking is the largest among all the total integrated values of the density ranking before the controller 170 determines the temperature setting. When there are multiple temperature settings having a same total value of the integrated values, the lower temperature is set as the determined temperature setting. The controller 170 adjusts an operation control value of the pretreatment liquid applier 110 based on the determined pre-processing application amount and temperature setting (step S1304).

If all the patch images have not been read (NO in step S1305), the controller 170 changes the temperature setting and changes the read image to be processed to an image that has been read (step S1306). Subsequently, the process proceeds to step S1301.

If all the read images have been read (YES in step S1305), the controller 170 calculates the total integrated value for each of the temperature settings (step S1307), and determines the pretreatment liquid drying temperature (step S1308). The controller 170 calculates the sum of the integrated values of the ranks of the ink adhesion amounts for each of the drying temperature settings, and compares the sum of the integrated values of each of the drying temperature settings. Subsequently, the controller 170 determines the drying temperature having the highest numerical value as the drying temperature.

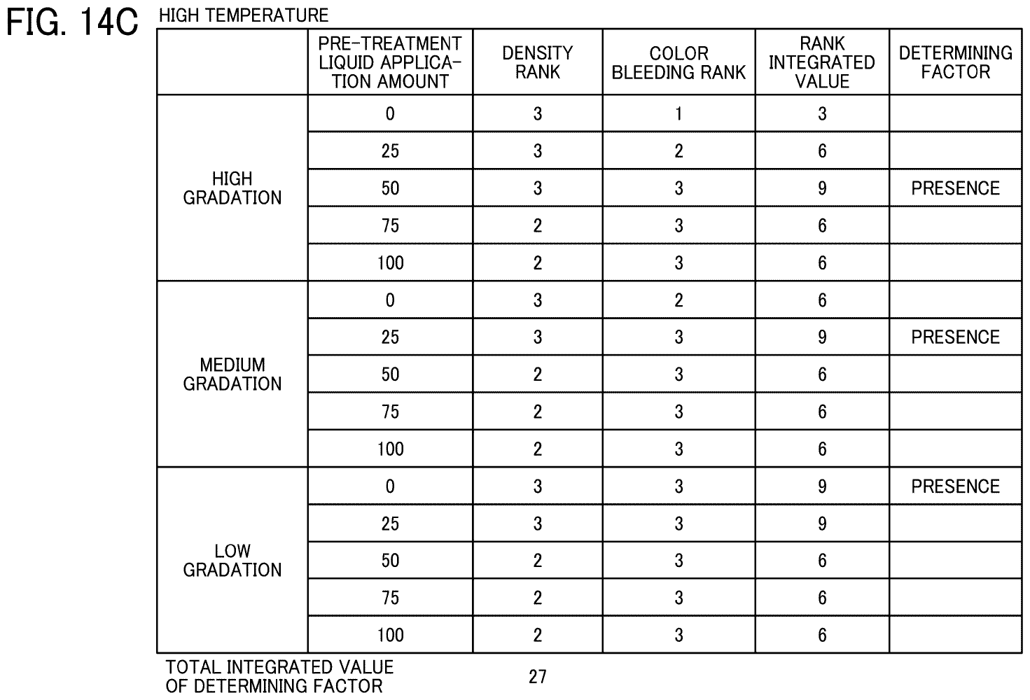

FIGS. 14A, 14B, and 14C illustrates an example of the pretreatment coating condition determination data calculated in the pretreatment coating condition determination process and stored in the storage area of the controller 170. As illustrated in FIGS. 14A, 14B, and 14C, the controller 170 calculates the density rank of high gradation, medium gradation, and low gradation (step S1302) and the color bleeding rank is calculated (step S1303) for each condition of the pre-processing drying temperature (low temperature, medium temperature, and high temperature), and the pretreatment liquid application amount is determined based on the rank integrated value (step S1304). Subsequently, the controller 170 calculates the total value of the integrated values of high gradation, medium gradation, and low gradation as the total integrated value of the determination condition (step S1307).

In FIG. 14A, the total integrated value at the low temperature is 18. In FIGS. 14B and 14C, the total integrated values at the medium temperature and the high temperature are both 27. Accordingly, the controller 170 determines that the medium temperature, which is lower than the high temperature, is the pre-treatment drying temperature. In addition, the controller 170 determines that the application amount of the pretreatment liquid Pr is 50% when the printed image has the high gradation, 25% when the printed image has the medium gradation, and 0% when the printed image has the low gradation.

As described above, the process in which pretreatment liquid Pr is applied to the sheet P, the process in which the pretreatment liquid Pr that has been applied to the sheet P is dried, and the process in which the specific image is formed on the sheet P on which the pretreatment liquid Pr has been dried, are sequentially performed to create the test charts T1 and T2. The controller 170 employs the test charts T1 and T2 to adjusts the application amount of the pretreatment liquid Pr and the drying conditions to the optimal conditions.

At this time, the controller 170 calculates the density data and the luminance data from the read image acquired by reading the specific image (test chart) formed on the sheet P.

By so doing, the controller 170 performs predetermined determination process to determine. Subsequently, the controller 170 adjusts the conditions of the pretreatment liquid application process and the pretreatment liquid drying process in accordance with the determination result.

In the example of FIGS. 14A, 14B, and 14C, the total values at the medium temperature and at the high temperature are equal. Accordingly, the controller 170 sets the drying temperature to be the medium temperature.

### Modification of Inkjet Printer 100

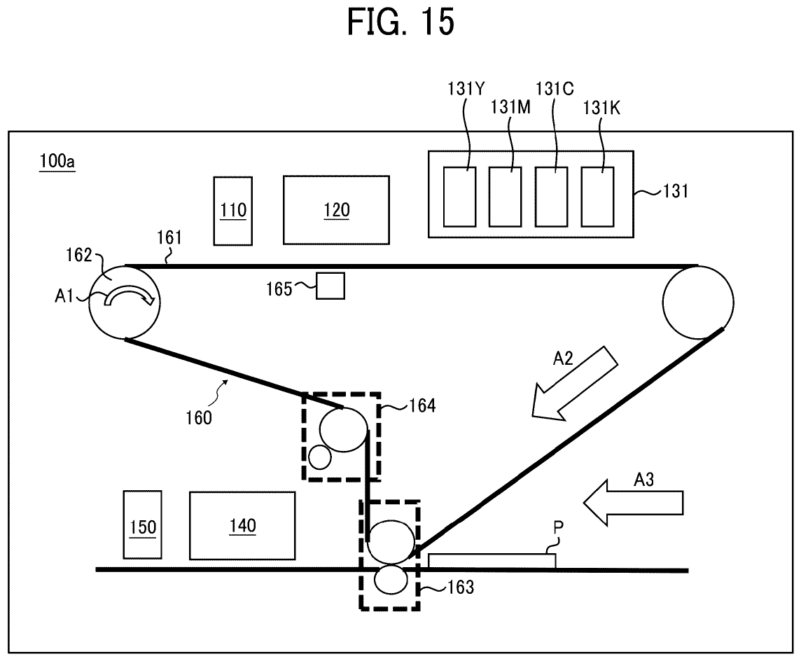

The inkjet printer 100 illustrated in FIG. 1 employs a so-called direct printing method. However, embodiments of the present disclosure are not limited by an image forming method, and can be applied to a so-called intermediate transfer method as illustrated in FIG. 15.

As illustrated in FIG. 15, an inkjet printer 100a that employs the intermediate transfer method includes an image former 130, a head unit 131, an intermediate transfer belt 161 as an intermediate transfer device included in a conveyor 160. The inkjet printer 100a forms a color image formed by a head unit 131 of an image former 130 on the intermediate transfer belt 161, and performs secondary transfer from the intermediate transfer belt 161 to a sheet P as a media. By so doing, forming an image.

When a rotator 162 rotates in a rotation direction A1, the intermediate transfer belt 161 moves in a movement direction A2.

The head unit 131 includes, for example, four color ink heads when full-color, i.e., four color image formation, is performed. Specifically, the head unit 131 includes a head 131Y for yellow ink, a head 131M for magenta ink, a head 131C for cyan ink, and a head 131K for black ink. A description is given below of an example in which the inkjet printer 100a performs image formation when liquid is ink and the head unit 131 applies ink to the sheet P.

However, the head unit 131 may include a head for other color than the head 131Y, the head 131M, the head 131C, and the head 131K. For example, the head unit 131 may include, for example, a head for white ink.

The head unit 131 forms an image on an image forming surface of the intermediate transfer belt 161. An image that is formed on the intermediate transfer belt 161 is referred to as an intermediate image in the following description.

The inkjet printer 100a further includes a transfer device 163 including, for example, a transfer roller. The transfer device 163 transfers the intermediate image formed on the intermediate transfer belt 161 to the sheet P conveyed in a conveyance direction A3.

The inkjet printer 100a further includes a cleaner 164 to clean the intermediate transfer belt 161. The cleaner 164 includes, for example, a roller and a blade. The cleaner 164 brings, for example, the roller or the blade into contact with the intermediate transfer belt 161 to perform cleaning to remove the intermediate image remaining on the intermediate transfer belt 161.

The inkjet printer 100a further includes a detector 165 including, for example, an optical sensor. However, the detector 165 may include an encoder. The detector 165 may be any type of sensor as long as the detector 165 can detect the position of the intermediate transfer belt 161. The detector 165 may include sensors at multiple positions or sensors of multiple types.

The inkjet printer 100a includes the pretreatment liquid applier 110 and the pretreatment liquid drier 120 upstream from the head unit 131 in the sheet conveyance direction.

The inkjet printer 100a according to the present embodiment includes the ink drier 140 and the image reader 150 downstream from the transfer device 163 in the sheet conveyance direction. The image reader 150 acquires an image formed on the sheet P, and the controller 170 executes the control processing described above.

In the embodiments of the present disclosure described above, the controller 170 determines whether the color bleeding occurs, and controls the application amount of the pretreatment liquid Pr and the drying temperature to prevent the color bleeding based on the determination result. However, the control based on the determination result of the color bleeding is not limited to such a configuration. For example, the determination result of the color bleeding may be applied to, for example, control of the application amount of the liquid ink, control of the particle diameter of the liquid ink.

The embodiments described above is based on an image forming method in which liquid ink is discharged to the sheet P, as in the inkjet printer 100. However, the control to prevent the color bleeding, according to embodiments of the present disclosure is not limited to the inkjet method, and can be applied to an electrophotographic method and offset printing method. For example, the fixing temperature of the toner, i.e., image developer, can be adjusted based on the color bleeding determination result.

As described above, according to the embodiment of the present disclosure, for example, regarding the application conditions of the pretreatment liquid, the optimal conditions can be determined based on the actually formed image.

The present disclosure is not limited to specific embodiments described above, and numerous additional modifications and variations are possible in light of the teachings within the technical scope of the appended claims. The above-described embodiments and modifications are some examples, and various modifications and modifications can be practiced from such examples by those skilled in the art. Such modifications are within the technical scope of the present disclosure.

Further, the control method described above may be achieved by, for example, a program. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

A description is given below of some aspects of the present disclosure.

### First Aspect

An image forming apparatus includes a pretreatment liquid applier to apply a pretreatment liquid to a sheet-shaped medium, a pretreatment liquid drier to dry the pretreatment liquid applied to the medium, an image former to form a specific image on the medium on which the pretreatment liquid has been dried, a medium conveyor to convey the medium to the pretreatment liquid applier, the pretreatment liquid drier, and the image former in this order and conveys the medium on which the image has been formed downstream in the sheet conveyance direction, an image reader disposed downstream from the image former in the sheet conveyance direction, the image reader to acquire a read image including the specific image formed on the medium and read by the image reader, and a controller to control the application amount of the pretreatment liquid and the drying condition of the pretreatment liquid.

The controller determines a control condition of the pretreatment liquid applier and the pretreatment liquid drier in accordance with a determination result based on luminance values of read images, and controls operations of the pretreatment liquid applier and the pretreatment liquid drier in accordance with the control condition.

### Second Aspect

In the image forming apparatus according to the first aspect, the controller adjusts an application amount of the pretreatment liquid applied to the medium in accordance with the determination result.

### Third Aspect

In the image forming apparatus according to the first or second aspect, the controller adjusts a drying condition of the pretreatment liquid applied to the medium in accordance with the determination result.

### Fourth Aspect

In the image forming apparatus according to any one of the first to third aspect, the read image is a specific image in which solid images filled with different specific colors are arranged adjacent to each other.

### Fifth Aspect

In the image forming apparatus according to the fourth aspect, the solid images are filled with different colors and densities of the solid images are different from each other.

### Sixth Aspect

In the image forming apparatus according to the fourth or fifth aspect, the specific image is an image in which multiple images each filled with a solid color and having a density different from each other are arranged in accordance with the magnitude of the density.

### Seventh Aspect

In the image forming apparatus according to any one of the fourth to sixth aspect, the controller determines a degree of color bleeding in a color bounding area in which images in different colors are arranged adjacent to each other, among the images filled with solid colors arranged adjacent to each other included in the specific image.

### Eighth Aspect

In the image forming apparatus according to the seventh aspect, the controller determines the degree of color bleeding based on a change amount of luminance values in a color bounding area in which images in different colors are arranged adjacent to each other, among the images filled with solid colors arranged adjacent to each other included in the specific image.

### Nineth Aspect

In the image forming apparatus according to the seventh aspect, the controller determines the degree of color bleeding based on a width of an area in which luminance values change significantly in a color bounding area in which images in different colors are arranged adjacent to each other, among the images filled with solid colors arranged adjacent to each other included in the specific image.

### Tenth Aspect

An image forming apparatus includes a pretreatment liquid applier to apply a pretreatment liquid to a sheet-shaped medium, a pretreatment liquid drier to dry the pretreatment liquid applied to the medium, an image former to form an image on the medium on which the pretreatment liquid has been dried, a medium conveyor to convey the medium to the pretreatment liquid applier, the pretreatment liquid drier, and the image former in this order and conveys the medium on which the image has been formed downstream in the sheet conveyance direction, an image reader disposed downstream from the image former in the sheet conveyance direction, the image reader to acquire a read image including the specific image formed on the medium and read by the image reader, and a controller to control the application amount of the pretreatment liquid and the drying condition of the pretreatment liquid based on the read image.

The controller adjusts operations of the pretreatment liquid applier and the pretreatment liquid drier based on a determination result of the color bleeding of the read images, and controls operations of the image former in accordance with the control condition.

### Eleventh Aspect

An image forming method includes applying a pretreatment liquid to a sheet-shaped medium, drying the pretreatment liquid applied to the medium, and forming an image on the medium on which the pretreatment liquid has been dried, in this order while conveying the medium, acquiring a read image reading the image formed on the medium after the image forming step; and adjusting processing conditions in the pretreatment liquid application step and the pretreatment liquid drying step in accordance with a determination result of density data and luminance data in the read image.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus comprising:
a conveyor to convey a medium in a conveyance direction;
a pretreatment liquid applier to apply a pretreatment liquid onto the medium conveyed by the conveyor;
an image former downstream from the pretreatment liquid applier in the conveyance direction, the image former to form a specific image on the medium on which the pretreatment liquid has been applied;
a dryer between the pretreatment liquid applier and the image former in the conveyance direction, the dryer to dry the pretreatment liquid applied onto the medium before the image former forms the specific image on the medium;
an image reader downstream from the image former in the conveyance direction, the image reader to read the specific image on the medium to acquire a read image; and
circuitry configured to:
determine an amount of the pretreatment liquid of the pretreatment liquid applier and a drying condition of the dryer based on the read image acquired by the image reader;
control the pretreatment liquid applier to apply the pretreatment liquid onto the medium for the amount of the pretreatment liquid determined based on the read image; and
control the dryer to dry the pretreatment liquid on the medium according to the drying condition determined based on the read image.

2. The image forming apparatus according to claim 1,
wherein the circuitry is further configured to control the pretreatment liquid applier to adjust the amount of the pretreatment liquid determined based on the read image.

3. The image forming apparatus according to claim 1,
wherein the circuitry is further configured to control the dryer to adjust the drying condition determined based on the read image.

4. The image forming apparatus according to claim 1,
wherein the circuitry causes the image former to form, on the medium, the specific image including solid images:
filled with different colors; and
arranged adjacent to each other.

5. The image forming apparatus according to claim 4,
wherein the circuitry causes the image former to form, on the medium, the solid image:
filled with different colors;
having different densities; and
arranged adjacent to each other.

6. The image forming apparatus according to claim 4,
wherein the circuitry causes the image former to form, on the medium, the specific image including multiple images:
filled with solid colors;
having different densities; and
arranged according to a magnitude of density.

7. The image forming apparatus according to claim 4,
wherein the circuitry is further configured to determine a degree of color bleeding in a part of the specific image in which images filled with solid colors of different colors are arranged adjacent to each other.

8. The image forming apparatus according to claim 7,
wherein the circuitry is configured to determine the degree of color bleeding based on a change amount of luminance values in the part of the specific image.

9. The image forming apparatus according to claim 7,
wherein the circuitry is configured to determine the degree of color bleeding based on a width of an illuminance-changing area in which a luminance value of the part of the specific image changes.

10. An image forming apparatus comprising
a pretreatment liquid applier to apply a pretreatment liquid to a medium;
a dryer to dry the pretreatment liquid applied to the medium;
an image former to form a specific image on the medium on which the pretreatment liquid has been dried;
a conveyor to;
convey the medium to the pretreatment liquid applier, the dryer, and the image former in this order; and
convey the medium on which an image has been formed downstream in a conveyance direction;
an image reader downstream from the image former in the conveyance direction, the image reader to acquire a read image of the image including the specific image formed on the medium and read by the image reader; and
circuitry configured to control an amount of the pretreatment liquid and a drying condition of the pretreatment liquid,
wherein the circuitry is configured to:
determine a control condition of the pretreatment liquid applier and the dryer in accordance with a determination result based on luminance values of read images; and
control operations of the pretreatment liquid applier and the dryer in accordance with the control condition.

11. An image forming method comprising:
applying a pretreatment liquid to a medium;
drying the pretreatment liquid applied to the medium;
forming a specific image on the medium on which the pretreatment liquid has been dried, in this order while conveying the medium;
reading an image including the specific image formed on the medium after the specific image is formed; and
determining a control condition of the applying the pretreatment liquid and the drying the pretreatment liquid in accordance with a determination result of color bleeding based on a luminance value of the read image.
